(19) United States
(12) Patent Application Publication
(10) Pub. No.: US 2013/0093368 A1
(43) Pub. Date: Apr. 18, 2013

(54) ELECTRIC DEVICES

(71) Applicant: Gogoro, Inc., New Taipei City (TW)

(72) Inventors: Hok-Sum Horace Luke, Mercer Island, WA (US); Matthew Whiting Taylor, North Bend, WA (US)

(73) Assignee: GOGORO, INC., New Taipei City (TW)

(21) Appl. No.: 13/650,498

(22) Filed: Oct. 12, 2012

Related U.S. Application Data
(60) Provisional application No. 61/546,411, filed on Oct. 12, 2011.
(60) Provisional application No. 61/583,456, filed on Jan. 5, 2012.
(60) Provisional application No. 61/583,984, filed on Jan. 6, 2012.
(60) Provisional application No. 61/615,123, filed on Mar. 23, 2012.
(60) Provisional application No. 61/615,143, filed on Mar. 23, 2012.
(60) Provisional application No. 61/615,144, filed on Mar. 23, 2012.

(51) Int. Cl. H02P 7/06; H02K 21/12

(52) U.S. Cl. 318/139; 310/156.01; 318/498

(57) ABSTRACT

Generally described, the present disclosure is directed to examples of electric devices that include first and second stator assemblies located within a rotor assembly. The configuration of the electric device, including the configuration of the first and second stator assemblies, results in the electric device generating a stronger magnetic field and therefore outputting a higher torque when current is provided to the second stator assembly and generating a weaker magnetic field and therefore outputting a higher rotational speed when current is provided to the first stator assembly.

### BACKGROUND

1. Technical Field

The subject matter described herein relates to electric devices and, in some embodiments, to electric devices configured to power other electric devices, such as an electric vehicle.

2. Description of the Related Art

The concern over the volume and cost of fossil fuels available in the future are fueling the proliferation of electric powered devices such as vehicles, including automobiles, trucks, motorcycles, scooters, golf carts, and utility carts, and other electric powered devices such as lawnmowers, chain saws, and the like. Electric motors that drive such vehicles and other electrically powered devices may include designs that have a drive shaft that is connected to an inner rotating rotor or to an outer rotating rotor.

Electric motors that include an outer rotating rotor may also be referred to as outrunner motors. Electric motors of a typical outrunner design include an outer rotor housing that spins around an inner stator that carries coils or windings. The outer rotor housing includes permanent magnets and may be connected to a drive shaft that is located on the axial centerline of the motor. In general, outrunner motors spin more slowly, while producing more torque than their inrunner counterparts where the outer housing is stationary. Outrunner motors are often chosen for specific applications due to their size and power-to-weight ratios. Because an outrunner motor is a type of brushless motor, a direct current, switched on and off at high frequency for voltage modulation, is typically passed through three or more nonadjacent windings of the stator, and the group of windings so energized is alternated electronically based on rotor position feedback.

An outrunner motor incorporated in an electric device, such as an electric vehicle, preferably produces a high amount of torque to provide quick acceleration of the vehicle, as well as high rotational speeds to allow the vehicle to travel at high velocities. In general, however, the amount of torque output by an outrunner motor increases as the magnetic field of the motor increases, while the rotational speed of the motor increases as the magnetic field of the motor decreases. As the popularity of electric powered vehicles and devices continues to increase, interest in electric motors capable of producing high output torques and high rotational speeds will also increase.

### BRIEF SUMMARY

As an overview, electric devices and systems including the same are described in the present disclosure. The embodiments of electric devices described in the present disclosure include at least two stator assemblies fixed to a stationary component, such as an axle or a support member, at a spaced apart distance from each other and located within a rotor assembly. The described electric devices may be used to power an electronic device, such as an electric vehicle. Examples of electric vehicles include motorcycles, scooters, golf carts, utility carts, riding lawnmowers, wheelchairs, automobiles or any other electric vehicle. Examples of electronic devices powered by the electric devices described herein include push lawnmowers, electric tools, and the like.

Embodiments of an electric device described herein include an axle, first and second stator assemblies, and a rotor assembly having a housing and a plurality of permanent magnets. The first and second stator assemblies each have a first pole and a first coil around the first pole. The first and second stator assemblies may be located within the rotor housing and spaced apart from each other along a length of the axle.

In accordance with embodiments of an electrically powered vehicle described herein, an electric device includes a rotor assembly, an axle, and first and second stator assemblies. The rotor assembly includes a housing and a plurality of permanent magnets coupled to the housing. Each of the first and second stator assemblies includes a pole and a coil around the pole. The first and second stator assemblies are positioned within the rotor assembly and spaced apart from each other along a length of the axle.

Embodiments of systems described herein include an electric device that includes a rotor assembly, an axle, and first and second stator assemblies. The rotor assembly includes a housing and a plurality of permanent magnets coupled to the housing. Each of the first and second stator assemblies includes a pole and a coil around the pole. The first and second stator assemblies are positioned within the rotor assembly at a spaced apart distance from each other along a length of the axle. The system may further include a power source and a controller coupled to the power source and the electric device. The controller may be configured to selectively electrically couple the power source to a respective one of the first and second stator assemblies.

Other embodiments of systems described herein include electric devices that include a rotor assembly, an axle, and first and second stator assemblies. The rotor assembly includes a housing and a plurality of permanent magnets on the housing. Each of the first and second stator assemblies includes a pole and a coil around the pole. The first and second stator assemblies are positioned within the rotor assembly at a spaced apart distance from each other along a length of the axle. The system may further include a power source, a switch and a controller configured to generate control signals. The switch may be coupled to the controller, the power source, and the electric device and may be configured to selectively couple the power source to a respective one of the first and second stator assemblies in response to receiving a control signal from the controller.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and they have been solely selected for ease of recognition in the drawings.

FIG. 1 is a cross-section view of a drive assembly comprising an electric device in accordance with aspects of the present disclosure;

FIG. 2 is a detailed cross-section view of the drive assembly of FIG. 1, wherein the drive assembly is attached to a portion of a device to be powered by the drive assembly;

FIG. 3 is a block diagram of a system comprising an electric device in accordance with aspects of the present disclosure;

FIG. 4 is a block diagram of another system comprising an electric device in accordance with aspects of the present disclosure; and

FIG. 5 is a cross-section view of another drive assembly comprising an electric device in accordance with aspects of the present disclosure, wherein the drive assembly is attached to a portion of a device to be powered by the drive assembly.

### DETAILED DESCRIPTION

It will be appreciated that, although specific embodiments of electric devices and systems have been described herein for purposes of illustration, various modifications may be made without departing from the spirit and scope of the present disclosure. Accordingly, the present disclosure is not limited except as by the appended claims.

In the following description, certain specific details are set forth in order to provide a thorough understanding of various aspects of the disclosed subject matter. However, the disclosed subject matter may be practiced without these specific details. In some instances, well-known structures and methods of fixing structure to each other comprising embodiments of the subject matter disclosed herein have not been described in detail to avoid obscuring the descriptions of other aspects of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

Reference throughout the specification to electric devices includes electric motors, electric generators, and the like. The phrase “electric device” should not be construed narrowly to limit it to the illustrated electric motor, but rather, the phrase “electric device” is broadly used to cover all types of structures that can generate electrical energy from a mechanical input or generate mechanical energy from an electrical input.

Specific embodiments are described herein with reference to electric vehicles; however, the present disclosure and the reference to electrically powered devices should not be limited to electric vehicles or to any of the other electrically powered devices described herein.

In the figures, identical reference numbers identify similar features or elements. The sizes and relative positions of the features in the figures are not necessarily drawn to scale.

Generally described, the present disclosure is directed to examples of electric devices that include first and second stator assemblies located within a rotor assembly. The configuration of the electric device, including the configuration of the first and second stator assemblies, results in the electric device generating a stronger magnetic field and therefore outputting a higher torque when current is provided to the second stator assembly and generating a weaker magnetic field and therefore outputting a higher rotational speed when current is provided to the first stator assembly. For instance, in some embodiments, at least one of the strength, size, and shape of a second set of permanent magnets proximate the second stator assembly may be different than those of a first set of permanent magnets proximate the first stator assembly. In other embodiments, the size, shape, configuration, and number of coils of the first stator assembly may be different than those of the second stator assembly.

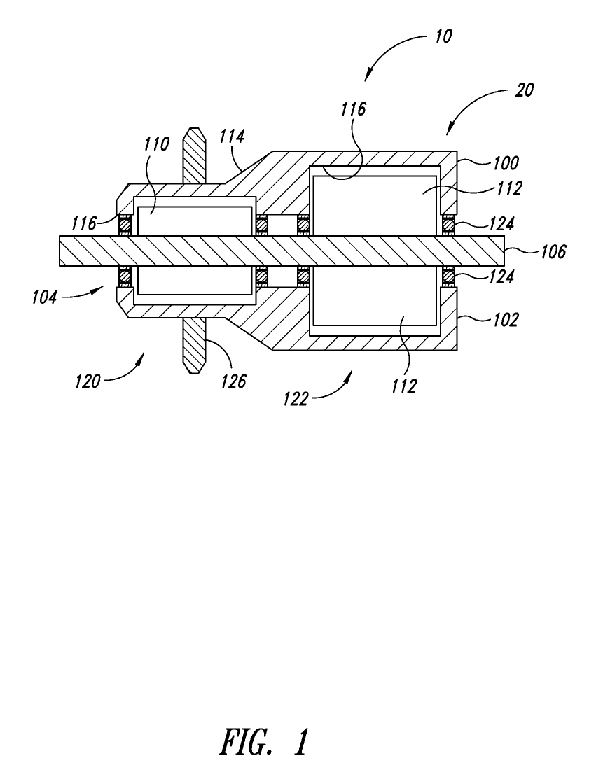

Referring now to FIG. 1, there is shown a drive assembly 10 that includes an electric device 20 having a rotor assembly 100 that includes a rotor housing 102 having a bore 104 therethrough. An elongate stationary axle 106 and first and second stator assemblies 110, 112 are located within bore 104 of rotor housing 102. As is illustrated in FIG. 1, the diameter of the cross section of first stator assembly 110 may be smaller than the diameter of the cross section of second stator assembly 112. In some embodiments, the length of the first stator assembly 110 may be less than the length of the second stator assembly 112.

Rotor housing 102 has an outer surface 114 and an inner surface 116 defined by bore 104. As seen in FIG. 1, rotor assembly 100 further includes first and second portions 120, 122 that are spaced along the length of axle 106. First and second stator assemblies 110, 112 are fixed to axle 106 at a spaced apart distance from each other along a length of axle 106. In particular, first stator assembly 110 is fixed to axle 106 so that first stator assembly 110 is unable to rotate relative to axle 106 and is proximate first portion 120 of rotor assembly 100, and second stator assembly 112 is fixed to axle 106 so that second stator assembly 112 is unable to rotate relative to axle 106 and is proximate second portion 122 of rotor assembly 100. Although only two stator assemblies are shown in FIG. 1, it is to be appreciated that drive assembly 10 may include more than two stator assemblies, e.g., three, four, or more stator assemblies.

Rotor assembly 100 is configured to rotate about a central axis of axle 106, while axle 106 and first and second stator assemblies 110, 112 are held stationary. Bearings 124 may be provided between the inner surface 116 of rotor housing 102 and the stationary axle 106 to reduce friction therebetween.

In the illustrated embodiment, the inner diameter of bore 104 of first portion 120 of rotor housing 102 may be smaller than the inner diameter of bore 104 of second portion 122 of rotor housing 102. Similarly, the inner diameter of rotor housing 102 proximate bearings 124 may different in view of the size of bearings 124. As is illustrated, the outer diameter of first portion 120 of rotor assembly 100 may be smaller than the outer diameter of second portion 122 of rotor assembly 100 with a tapered section therebetween in order to reduce the amount of material used and to reduce the size of rotor assembly 100.

In the illustrated embodiment, a drive wheel 126 is fixed to the outer surface 114 of rotor housing 102 and is configured to rotate with rotor assembly 100. Although drive wheel 126 is shown as fixed to first portion 120 of rotor housing 102, it is to be appreciated that drive wheel 126 may be fixed to any portion of rotor housing 102 or to another device that is secured to rotor housing 102 and is configured to rotate with rotor housing 102. Although not shown, the drive wheel 126 may be configured to transfer rotational motion of the drive wheel to linear motion of a structure, such as a chain or belt, cooperating with the drive wheel.

As will be explained in more detail, components of electric device 20 that are associated with second stator assembly 112 may be designed so as to cause electric device 20 to maximize its torque output. In that regard, the components of electric device 20 that are associated with second stator assembly 112 may be designed to generate a stronger magnetic field than the components associated with first stator assembly 110. Components of electric device 20 that are associated with first stator assembly 110 may be designed so as to cause electric device 20 to maximize its speed output. In that regard, the components of electric device 20 that are associated with first stator assembly 110 may be designed to generate a weaker magnetic field than the components associated with second stator assembly 112.

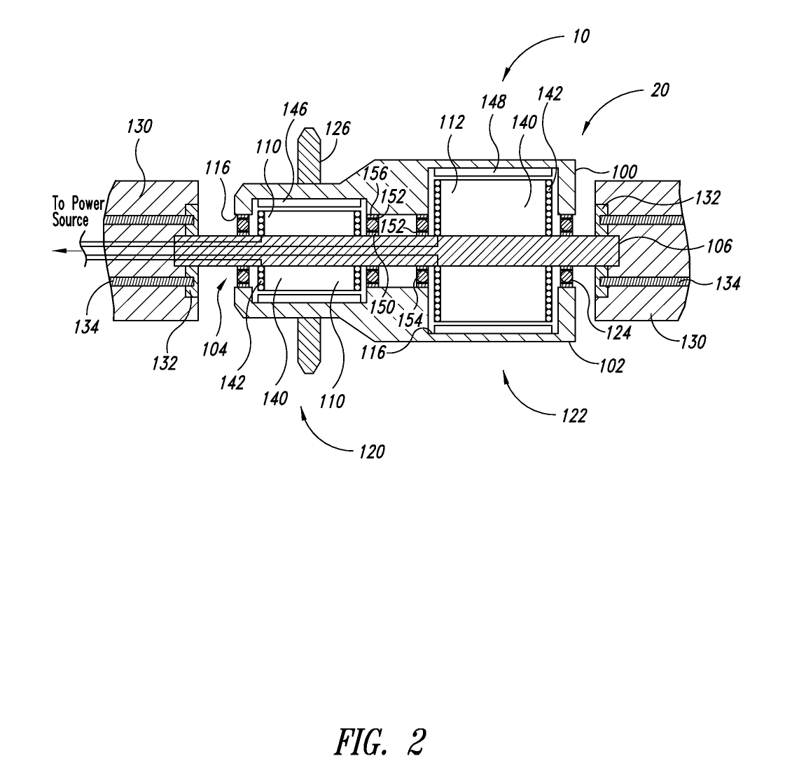

Turning now to FIG. 2, there is shown a more detailed cross-section view of drive assembly 10 of FIG. 1. In the illustrated embodiment, drive assembly 10 is mounted at each end to a portion 130 of a vehicle frame, such as a portion of a motorcycle or scooter chassis. In particular, each end of axle 106 is fixed to a coupler 132 that is received into a recess in respective vehicle frame portions 130. In the illustrated embodiment, each coupler 132 includes two threaded bores for receiving threaded ends of bolts 134 which pass through apertures in frame portions 130 and serve to fasten couplers 132 to respective vehicle frame portions 130. When couplers 132 are fastened to respective vehicle frame portions 130, they are not able to move relative to vehicle frame portions 130. In that regard, axle 106 is fixed to vehicle frame portions 130 and is not able to move relative to vehicle frame portions 130. Other techniques for attaching couplers to a vehicle frame portion can be used, for example, welding, rivets, compression fittings, set screws and other known techniques. Furthermore, it is to be appreciated that the mechanisms used to mount the drive assembly to the portions of the vehicle frame may be any mechanism configured to mount a stationary portion of the drive assembly to the vehicle frame.

Each of first and stator assemblies 110, 112 includes at least one pole 140 that is wrapped with at least one conductive coil 142 a particular number of turns, including a single turn, around an outer surface of pole 140. In some embodiments, each of first and second stator assemblies 110, 112 includes a plurality of poles 140, each of which is wrapped with one or more coils 142 a particular number of turns. It is to be understood that pole 140 and coil 142 may be formed from conventional materials, including electrically conductive materials.

Although not illustrated, an end of pole 140 and coil 142 that is opposite axle 106 may include a stator tooth of conventional design. Each of poles 140 in first and second stator assemblies 110, 112 may be fixed to axle 106 and therefore are not able to move relative to axle 106. Furthermore, because coil 142 is wrapped around the stationary pole 140, coil 140 is indirectly fixed to axle 106 and is also unable to move with respect to axle 106. It is to be appreciated that pole 140 can be fixed to axle 106 by conventional means, such as being extruded as an integral element of a stator body that includes a bore for receiving the axle, set screws, welding, compression fittings, bolts, or other fastening means.

Inner surface 116 of rotor housing 102 may include a first set of permanent magnets 146 proximate first stator assembly 110 and a second set of permanent magnets 148 proximate second stator assembly 112. First set of permanent magnets 146 is configured to generate a first magnetic field, and second set of permanent magnets 148 is configured to generate a second magnetic field. First set of permanent magnets 146 includes a particular number of magnets that are sized and located so as to interact with adjacent poles 140 and coils 142 of first stator assembly 110. Second set of permanent magnets 148 includes a particular number of magnets that are sized and located so as to interact with adjacent poles 140 and coils 142 of second stator assembly 112.

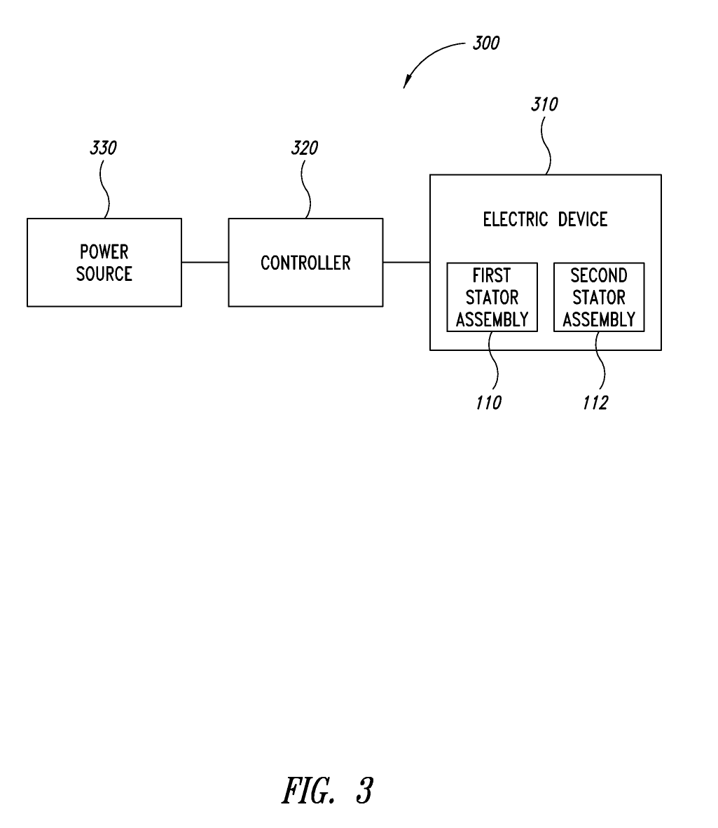

Each end of the coil 142 wrapped around pole 140 of each of first and second stator assemblies 110, 112 may be selectively coupled to terminals of a power source (FIG. 3) using conventional techniques. The power source may be any power source, including a battery. One of the terminals of the power source is configured to selectively supply a current to coil 142 in each one of first and second stator assemblies 110, 112. As current flows through coils 142 of first stator assembly 110, a first electromagnet field is generated. As current flows through coils 142 of second stator assembly 112, a second electromagnetic field is generated. The first electromagnetic field interacts with the first magnetic field generated by first set of permanent magnets 146 and causes rotor assembly 100 to rotate about axle 106. Similarly, the second electromagnetic field interacts with the second magnetic field generated by second set of permanent magnets 148 and causes rotor assembly 100 to rotate about axle 106.

As indicated above, the components of electric device 20 that are associated with second stator assembly 112 may be designed to generate a stronger magnetic field than the components associated with first stator assembly 110, thereby increasing the output torque of electric device 20. In one embodiment, at least one of the strength, size, and shape of second set of permanent magnets 148 may be different than those of first set of permanent magnets 146, such that second set of permanent magnets 148 generates a greater second magnetic field. For instance, in one embodiment, second set of permanent magnets 148 may be at least one of greater strength and larger size than those of first set of permanent magnets 146. In another embodiment, second set of permanent magnets 148 may have a curved surface proximate a surface of coils 142 of second stator assembly 112, while first set of permanent magnets 146 has a flat surface. In yet another embodiment, the inner diameter of bore 104 may be adjusted to adjust the magnetic strength produced by each one of first and second set of permanent magnets 146, 148.

In another embodiment, the components of first and second stator assemblies 110, 112 themselves may be different so as to generate different strengths of first and second electromagnetic fields. In general, coils 142 of second stator assembly 112 may be configured to produce a greater current therein by using conventional designs. In that regard, second stator assembly 112 will be configured to generate a greater electromagnetic field than first stator assembly 110. For example, in one embodiment, coils 142 of second stator assembly 112 may be longer than coils 142 of first stator assembly 110. In that regard, coils 142 of second stator assembly 112 may be wrapped around poles 140 a greater number of turns than coils 142 of first stator assembly 110. In addition or alternatively, coil 142 of second stator assembly 112 may be larger in diameter than coil 142 of first stator assembly 110. In addition or alternatively, the number of poles 140 in second stator assembly 112 may be greater than the number of poles 140 in first stator assembly 110. In other embodiments, the configuration and shape of coils 142 as they are wrapped around poles 140 may be different for second stator assembly 112 than for first stator assembly 110. As indicated above, the length and/or the diameter of second stator assembly 112, including poles 140 of second stator assembly 112, may be greater than those of first stator assembly 110.

In yet other embodiments, the location of the first and second stator elements 110, 112 relative to first and second set of permanent magnets 146, 148 may be used to generate different magnetic field strengths. It is to be appreciated that any of the techniques described herein may be combined to generate different strengths between the first and second electromagnetic fields.

It is to be appreciated that in some embodiments the components discussed above for adjusting the first and second electromagnetic fields generated by first and second stator assemblies 110, 112 and the components discussed above for adjusting the first and second magnetic fields generated by first and second set of permanent magnets 146, 148 may be varied in order to affect the output torque and output speed of the electric device 20.

As discussed above, one or more bearings 124 may be provided between inner surface 116 of rotor housing 102 and axle 106. Bearings 124 may be any type of bearings or equivalents thereof that are configured to reduce frictional forces between the rotating rotor housing 102 and the stationary axle 106. In the illustrated embodiment, bearings 124 are ball bearings, which include an inner race 150 fixed to axle 106, a ball retainer 152 configured to receive and retain a ball 154, and an outer race 156 fixed to inner surface 116 of rotor housing 102. In that regard, outer race 156 rotates with rotor assembly 100, inner race 150 is held stationary with axle 106, and ball 124 rotates along surfaces of inner and outer races 150, 156.

Turning now to FIG. 3, there is shown one embodiment for a system 300 that may comprise an electric device 310 described herein, such as electric device 20 shown in FIGS. 1 and 2. System 300 includes a controller 320, such as a microprocessor or digital circuitry, electrically coupled to a power source 330, and to electric device 310. Using known techniques, controller 320 is configured to selectively couple power source 330 to electric device 310. In particular, controller 320 is configured to selectively couple power source 330 to ends of coil 142 (FIG. 2) of first stator assembly 110 and ends of coil 142 of second stator assembly 112 to generate a current therein.

In use, controller 330 may couple coils of second stator assembly 112 to power source 330 to allow electric device 310 to output a large torque to an electrically powered device that is being driven by electric device 310.

In response to electric device 310 reaching a particular speed, i.e., rotor housing 102 reaching a particular number of rotations per minute, controller 320 may be configured to decouple coils of second stator assembly 112 from power source 330 and to couple coils of first stator assembly 110 to power source 330. In doing so, electric device 310 may be able to rotate its rotor housing at a higher speed.

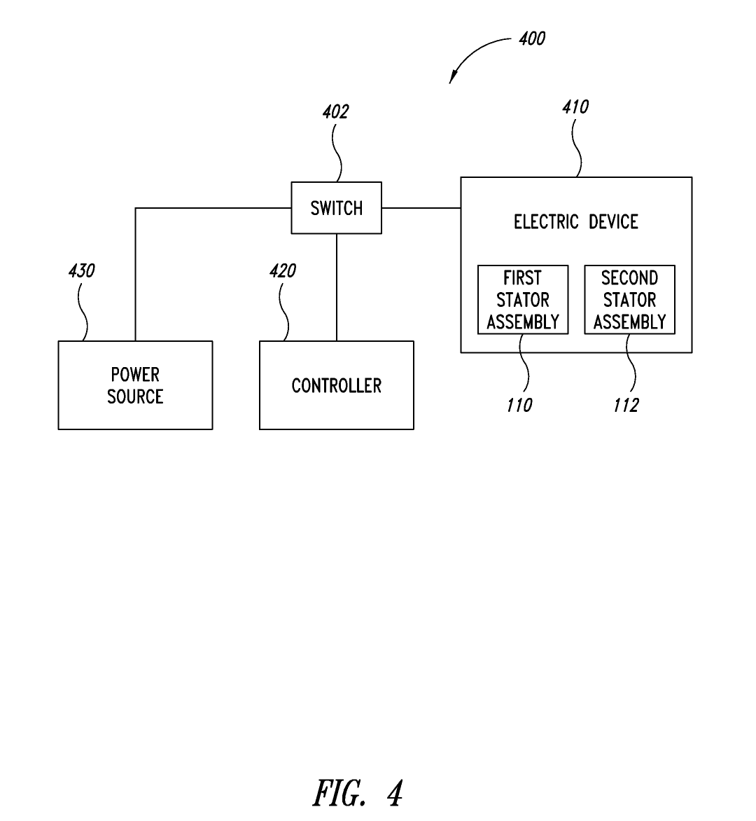

FIG. 4 illustrates another embodiment of a system 400 comprising an electric device 410. System 400 is substantially identical in components and operation of system 300 of FIG. 3, except that system 400 further includes a switch, which will be described in more detail below. For clarity in the ensuing descriptions, numerical references of like elements are similar but in the 400 series for the illustrated embodiment. In the interest of brevity, the components having similar structure and function will not be repeated.

System 400 includes a switch 402 coupled to a controller 420, a power source 430, and electric device 410. Controller 420 is configured to provide control signals to switch 402. In response to receiving control signals, switch 402 is configured to selectively close and open thereby coupling and decoupling, respectively, power source 430 to and from electric device 410.

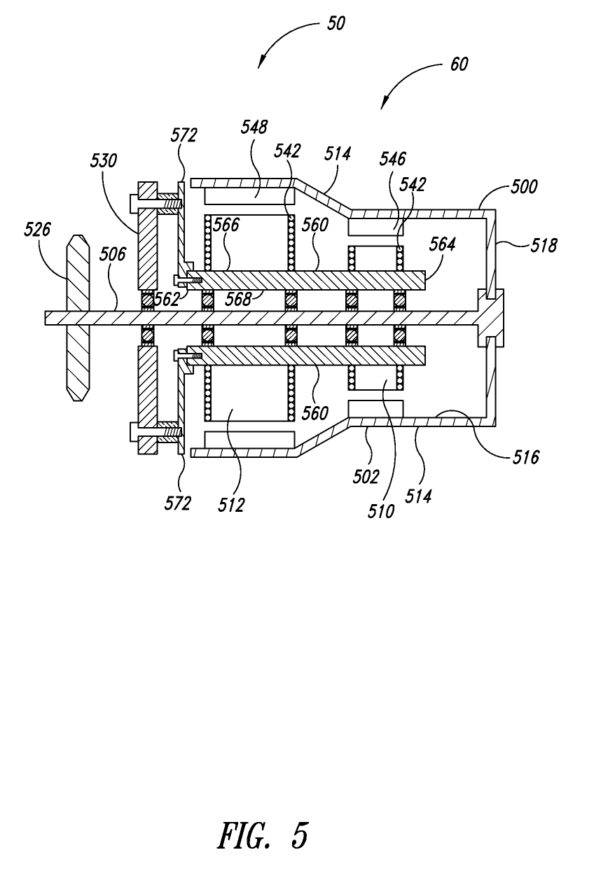

Turning now to FIG. 5, there is shown another embodiment of a drive assembly 50 comprising an electric motor 60 in accordance with aspects of the present disclosure. Drive assembly 50 is substantially identical in components and operation to drive assembly 10 of FIGS. 1 and 2, except that the axle of the drive assembly 50 is fixed to the rotor housing and configured to rotate with the rotor assembly, which will be described in more detail below. For clarity in the ensuing descriptions, numerical references of like elements are similar but in the 500 series for the illustrated embodiment. In the interest of brevity, the components having similar structure and function will not be repeated.

Drive assembly 50 includes first and second stator assemblies 510, 520 that are located within a rotor assembly 500. Rotor assembly 500 includes a rotor housing 502 having outer and inner surfaces 514, 516 and a rotor cap 518. An end of an axle 506 is fixed to rotor cap 518 of the housing 502 by any conventional means that allows axle 502 to rotate with rotor assembly 500. It is to be appreciated that drive wheel 526 may be secured to axle 506, as is shown in the illustrated embodiment, or to rotor housing 502, as is shown in the embodiment of FIGS. 1 and 2.

Drive assembly 50 may further include a support member 560 having opposite, first and second ends 562, 564 and opposite, first and second surfaces 566, 568. As shown in FIG. 5, first end 562 of support member 560 may be fixed to a stationary endplate 572. In that regard, support member 560 is not able to move relative to stationary endplate 572. Endplate 572 is further fixed to a portion 530 of an electronic device incorporating drive assembly 50, such as to a portion of a vehicle frame. It should be appreciated, however, that in some embodiments, first end 562 of support member 560 may be fixed directly to a portion 530 of the vehicle frame. The above-described fixing may be done by conventional means, such as by fasteners as is illustrated or by welding.

First and second stator assemblies 510, 512 are fixed to first surface 566 of support member 560 at a spaced apart distance from each other along a length of support member 560 or axle 506. In that regard, first and second assemblies 510, 512 are held stationary relative to support member 560. Rotor assembly 500 surrounds first and second stator assemblies 510, 512 such that a first set of permanent magnets 546 located on inner surface 516 of rotor housing 502 are proximate first stator assembly 510 and a second set of permanent magnets 548 located on inner surface 516 of rotor housing 502 are proximate second stator assembly 512.

As current is provided to coil 542 of one of first and second stator assemblies 510, 512, rotor assembly 502 and axle 506 are configured to rotate about a central axis of axle 506. As described above, support member 560 and first and second stator assemblies 510, 512 are held stationary relative to rotating rotor assembly 500 and rotating axle 506. Bearings 524 may be provided between second surface 568 of the stationary support member 560 and rotating axle 506 to reduce the frictional forces therebetween.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 61/583,984 entitled “INTERNALLY COOLED DRIVE ASSEMBLY FOR ELECTRIC POWERED DEVICE” and filed Jan. 6, 2012, (Attorney Docket No. 170178.410P1); U.S. provisional patent application Ser. No. 61/546,411 entitled “DRIVE ASSEMBLY FOR ELECTRIC POWERED DEVICE” and filed Oct. 12, 2011 (Attorney Docket No. 170178.411P1); U.S. provisional patent application Ser. No. 61/615,123 entitled “DRIVE ASSEMBLY FOR ELECTRIC POWERED DEVICE” and filed Mar. 23, 2012 (Attorney Docket No. 170178.413P1); U.S. provisional patent application Ser. No. 61/583,456 entitled “ELECTRIC DEVICES” and filed Jan. 5, 2012 (Attorney Docket No. 170178.414P1); U.S. provisional patent application Ser. No. 61/615,144 entitled “ELECTRIC DEVICE DRIVE ASSEMBLY AND COOLING SYSTEM” and filed Mar. 23, 2012 (Attorney Docket No. 170178.415P1); U.S. provisional patent application Ser. No. 61/615,143 entitled “DRIVE ASSEMBLY AND DRIVE ASSEMBLY SENSOR FOR ELECTRIC DEVICE” and filed Mar. 23, 2012 (Attorney Docket No. 170178.416P1), are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electric device comprising:
an axle;
a first stator assembly having a first pole and a first coil around the first pole;
a second stator assembly having a second pole and a second coil around the second pole; and
a rotor assembly having a housing and a plurality of permanent magnets coupled to the housing, wherein the first and second stator assemblies are located within the rotor assembly and are spaced apart from each other along a length of the axle.

2. The electric device of claim 1, wherein the first coil of the first stator assembly has a smaller diameter than the second coil of the second stator assembly.

3. The electric device of claim 2, wherein the first coil of the first stator assembly has a smaller length than the second coil of the second stator assembly.

4. The electric device of claim 2, wherein the plurality of permanent magnets comprises a first set of permanent magnets that correspond to the first stator assembly and a second set of permanent magnets that correspond to the second stator assembly, wherein the first set of permanent magnets have a smaller magnetic strength than the second set of permanent magnets.

5. The electric device of claim 1, wherein the first and second stator assemblies are fixed to the axle.

6. The electric device of claim 1, wherein the axle is fixed to the housing of the rotor assembly, and wherein the axle and the rotor assembly are configured to rotate relative to the first and second stator assemblies.

7. The electric device of claim 1, further comprising a drive mechanism fixed to one of the housing of the rotor assembly and the axle.

8. The electric device of claim 1, wherein first stator assembly is proximate a first end of the housing of the rotor assembly and the second stator assembly is proximate a second end of the housing of the rotor assembly.

9. The electric device of claim 8, wherein the housing of the rotor assembly has a first diameter proximate the first end and a second diameter that is different from the first diameter proximate the second end.

10. An electrically powered vehicle comprising:
an electric device that includes a rotor assembly, an axle, and first and second stator assemblies, the rotor assembly having a housing and a plurality of permanent magnets on the housing, each of the first and second stator assemblies having a pole and a coil wrapped around the pole, wherein the first and second stator assemblies are positioned within the rotor assembly and spaced apart from each other along a length of the axle.

11. The electrically powered vehicle of claim 10, wherein the pole of the second stator assembly has at least one of a larger diameter, a longer length, and a coil wrapped around the pole a larger number of turns than the pole of the first stator assembly.

12. The electrically powered vehicle of claim 10, wherein the first and second stator assemblies each include a plurality of poles, and wherein the second stator assembly includes a larger number of poles than the first stator assembly.

13. The electrically powered vehicle of claim 10, wherein the first and second stator assemblies are fixed to the axle.

14. The electrically powered vehicle of claim 10, wherein an end of the axle is fixed to the housing of the rotor assembly, and wherein the axle and the rotor assembly are configured to rotate relative to the first and second stator assemblies.

15. A system comprising:
an electric device that includes a rotor assembly, an axle, and first and second stator assemblies, the rotor assembly having a housing and a plurality of permanent magnets on the housing, each of the first and second stator assemblies having a pole and a coil wrapped around the pole, wherein the first and second stator assemblies are positioned within the rotor assembly at a spaced apart distance from each other along a length of the axle;
a power source; and
a controller coupled to the power source and the electric device, the controller configured to selectively electrically couple the power source to a respective one of the first and second stator assemblies.

16. The system of claim 15, wherein the pole of the second stator assembly has at least one of a larger diameter, a longer length, and a coil wrapped around the pole a larger number of turns than the pole of the first stator assembly.

17. The system of claim 15, wherein the first and second stator assemblies each include a plurality of poles, and wherein the second stator assembly includes a larger number of poles than the first stator assembly.

18. The system of claim 15, wherein the first and second stator assemblies are fixed to the axle.

19. The system of claim 15, wherein the axle is fixed to the housing of the rotor assembly, and wherein the axle and the rotor assembly are configured to rotate relative to the first and second stator assemblies.

20. A system comprising:
an electric device that includes a rotor assembly, an axle, and first and second stator assemblies, the rotor assembly having a housing and a plurality of permanent magnets on the housing, each of the first and second stator assemblies having a pole and a coil around the pole, wherein the first and second stator assemblies are positioned within the rotor assembly at a spaced apart distance from each other along a length of the axle;
a power source;
a controller, the controller configured to generate control signals; and
a switch coupled to the controller, the power source and the electric device, the switch configured to selectively couple the power source to a respective one of the first and second stator assemblies in response to receiving a control signal from the controller.

21. The system of claim 20, wherein the power source is a battery.

22. The system of claim 20, wherein the pole of the second stator assembly has at least one of a larger diameter, a longer length, and a coil wrapped around the pole a larger number of turns than the pole of the first stator assembly.

23. The system of claim 20, wherein the first and second stator assemblies each include a plurality of poles, and wherein the second stator assembly includes a larger number of poles than the first stator assembly

24. The system of claim 20, wherein the axle is fixed to the housing of the rotor assembly, and wherein the axle and the rotor assembly are configured to rotate relative to the first and second stator assemblies

25. The system of claim 20, wherein the first and second stator assemblies are fixed to the axle.
